(19) United States
(12) Patent Application Publication
(10) Pub. No.: US 2005/0111034 A1
(43) Pub. Date: May 26, 2005

(54) Printing system

(76) Inventors: Toshihiko Karasaki, Kawachinagano-shi (JP); Hitoshi Hagimori, Ikoma-gun (JP); Yong Xin Huang, Kobe-shi (JP); Masahito Niikawa, Sakai-shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/979,354

(22) Filed: Nov. 2, 2004

(30) Foreign Application Priority Data
Nov. 6, 2003 (JP) P2003-376670

(51) Int. Cl. G06F 15/00

(52) U.S. Cl. 358/1.15; 358/302

(57) ABSTRACT

In the printing system, an image captured by a digital camera is recorded in a memory card, and is transmitted to a printer through the memory card. The printer prints the captured image in the inserted memory card. The number of prints of the captured image is set by a predetermined operation in the digital camera. This setting information is stored in the memory card, and the printer prints on the basis of the set information. In the case of trial use at a shop counter, a memory card for trial use is used. The printer is set to a “trial use mode” when the inserted memory card is for trial use, and limits the actual number of prints of the captured image to two or less. As a result, mass printing by trial use can be prevented, and the printing system can give easy trial use to customers.

This application is based on application No. 2003-376670 filed in Japan, the contents of which are hereby incorporated by reference.

### BACKGROUND OF THE INVENTION

1. Field of the Invention

The present invention relates to a technique of printing an image captured by a digital camera.

2. Description of the Background Art

Recently, images captured by a digital camera and recorded in a memory card or the like have been generally printed by users themselves using self-printers placed at the counter of a camera shop, a consumer-use printer or the like.

In the case where the printer is conformity with DPOF (R) (Digital Print Order Format) standards, when the memory card recording the images to be printed includes an auto-print file for designating printing conditions such as the number of prints of the image, the printer reads the printing conditions in the auto-print file, and prints in accordance with the printing conditions. Therefore, when the user creates such auto-print file, a desired image can be printed by the desired number of prints. Generally, the auto-print file is created in the memory card by performing a predetermined operation in the digital camera.

As described above, the function of printing using the auto-print file of digital camera and printer is very convenient in the case of printing an image of the digital camera by means of the printer. However, many users do not know the function, and such convenient function has not been utilized sufficiently.

In order to address the above circumstances, it is considered that at the counter of a stop selling digital cameras or printers, customers of the shop which will buy them use the digital camera and the printer as trial use and experience the actual printing of images using the auto-print file, thereby recognizing the convenience of the function. However, when a customer not accustomed to use is allowed to use freely, various problems may occur due to wrong handling such as setting of a great number of prints to result in many misprints. Hence, it has not been easy to allow the customer to freely give trial use of the above function.

On the other hand, there has been an increasing demand for development of technique of effectively providing information describing a creating method of an auto-print file in a digital camera to customers which will buy the digital camera.

### SUMMARY OF THE INVENTION

The present invention is directed to a digital camera having a first mode for trial use and a second mode for non-trial use.

According to the present invention, the digital camera comprises: an image capturing part for capturing an image of a subject to acquire the captured image and recording the captured image in a memory device; and a processing part for performing a printing related process regarding printing of the captured image, wherein the processing part changes a content of the printing related process between the first mode and the second mode.

In the first mode for trial use, a printing related process which is different from that in the second mode is performed, so that a printing related process of the digital camera can be suitable for trial use in a shop counter. Thereby, a customer of a shop can easily experience the function of printing of a captured image.

According to an aspect of the present invention, in the first mode, the processing part adds description information about the digital camera to the captured image to generate data for printing.

Since it is possible to print the captured image and, also, the description information about the digital camera, the description information about the digital camera can be effectively provided to a customer.

The present invention is also directed to a printer having a first mode for trial use and a second mode for non-trial use.

According to the present invention, the printer comprises: an acquisition part for acquiring an image captured by a digital camera and stored in a memory device; a processing part for performing a printing related process regarding printing of the captured image; and a printing part for printing the captured image, wherein the processing part changes a content of the printing related process between the first mode and the second mode.

In the first mode for trial use, a printing related process which is different from that in the second mode is performed, so that a printing related process of the printer can be suitable for trial use in a shop counter. Thereby, a customer of a shop can easily experience the function of printing of a captured image.

According to an aspect of the present invention, the captured image contains identification information indicative of the type of the digital camera used for image capturing, in the first mode, the processing part acquires description information about the digital camera, by which the captured image is acquired, on the basis of the identification information contained in the captured image, and the processing part adds the acquired description information to the captured image to generate data for printing.

Since it is possible to print the captured image and, also, the description information about the digital camera by which the captured image is acquired, the description information about the digital camera can be effectively provided to a customer.

The present invention is also directed to a printing system including a digital camera for capturing an image of a subject to acquire the captured image and a printer for printing the captured image.

The present invention is also directed to a program product having a program being executable by a computer provided in relation to a printing system including a digital camera for capturing an image of a subject to acquire the captured image and a printer for printing the captured image.

It is therefore an object of the present invention to give an easy experience of the function regarding printing of an image to a customer of a shop.

It is another object of the present invention to effectively provide description information about a digital camera to a customer.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a printing system according to a first preferred embodiment of the present invention;

FIGS. 2 and 3 are perspective views showing an appearance configuration of a digital camera;

FIG. 4 is a functional block diagram showing a main internal configuration of the digital camera;

FIG. 5 illustrates an example of an image file;

FIG. 6 is a flowchart showing a setting accepting process;

FIG. 7 illustrates a screen display example of a liquid crystal monitor in the setting accepting process;

FIG. 8 is an enlarged view showing an operation panel;

FIG. 9 is a functional block diagram showing a main internal configuration of a printer;

FIG. 10 illustrates a data configuration example in a memory card;

FIG. 11 is a flowchart basically showing an image acquiring/printing process according to the first preferred embodiment;

FIGS. 12 and 13 are flowcharts showing a printing process;

FIG. 14 is a flowchart showing a application mode determining process according to the first preferred embodiment;

FIG. 15 illustrates an example of a photograph in which a captured image and an ad image are arranged

FIG. 16 is a flowchart showing a setting determining process;

FIG. 17 illustrates a printing system according to a third preferred embodiment of the present invention;

FIG. 18 is a flowchart showing an application mode determining process according to the third preferred embodiment;

FIG. 19 is a flowchart basically showing an image acquiring/printing process according to the third preferred embodiment;

FIG. 20 is a flowchart showing a printing instruction process;

FIG. 21 illustrates a screen display example of a liquid crystal monitor in the printing instruction process; and

FIGS. 22 and 23 illustrate modifications of a printing system.

### DESCRIPTION OF THE PREFERRED EMBODIMENTS

Hereinafter, description will be given of preferred embodiments of the present invention with reference to the drawings.

1. First Preferred Embodiment

1-1. Overview of Printing System

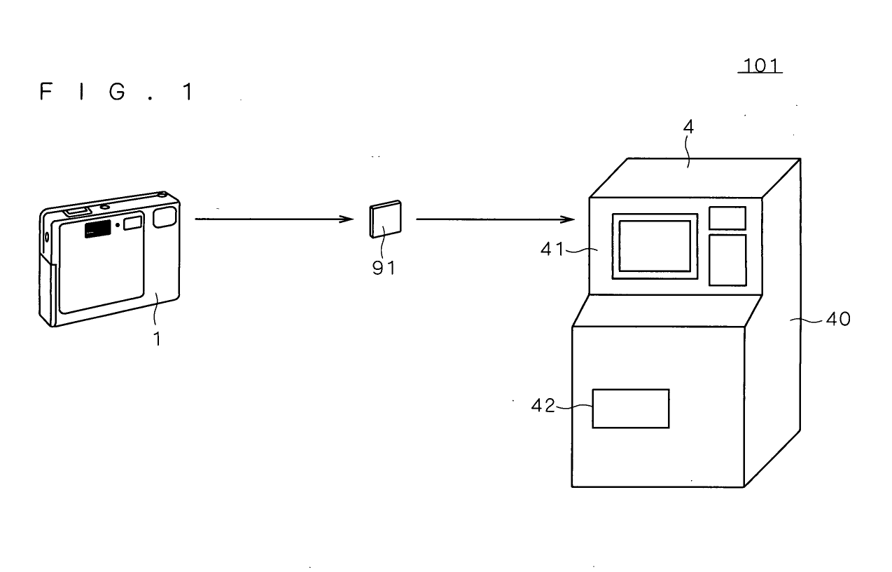

FIG. 1 illustrates a printing system according to a first preferred embodiment of the present invention. As shown in FIG. 1, the printing system 101 has a digital camera 1 which captures an image of a subject to acquire the captured image and a printer 4 which prints the captured image. The printer 4 is constituted as a self printer (digital photograph vending machine) which accepts an operation by a customer to print a digital image on a chargeable basis.

The printing system 101 is placed at a counter or the like of a shop which sells a digital camera and the like, for the purpose of making customers which will buy the digital camera 1 to experience acquisition of an image by the digital camera 1 and printing of the image by the printer 4. Accordingly, the printer 4 is used as normal application for providing a printing service on a chargeable basis in some cases and is used as trial use application for the purpose of experience. Hereinafter, a process of the printing system 101, wherein an image is captured by the digital camera 1 and the captured image is printed by the printer 4, is referred to as a “image acquiring/printing process”.

Both of the digital camera 1 and the printer 4 can insert a memory card 91 thereinto. The memory card is a portable recording medium (more typically, a memory device), and an image captured by the digital camera 1 is transmitted to the printer 4 through the memory card 91.

1-2. Configuration of Digital Camera

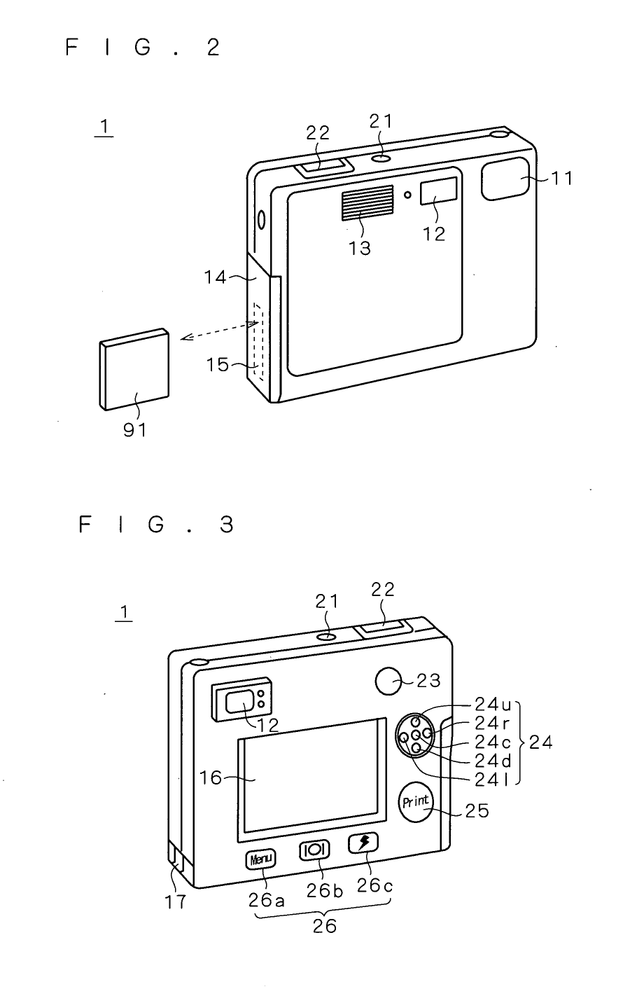

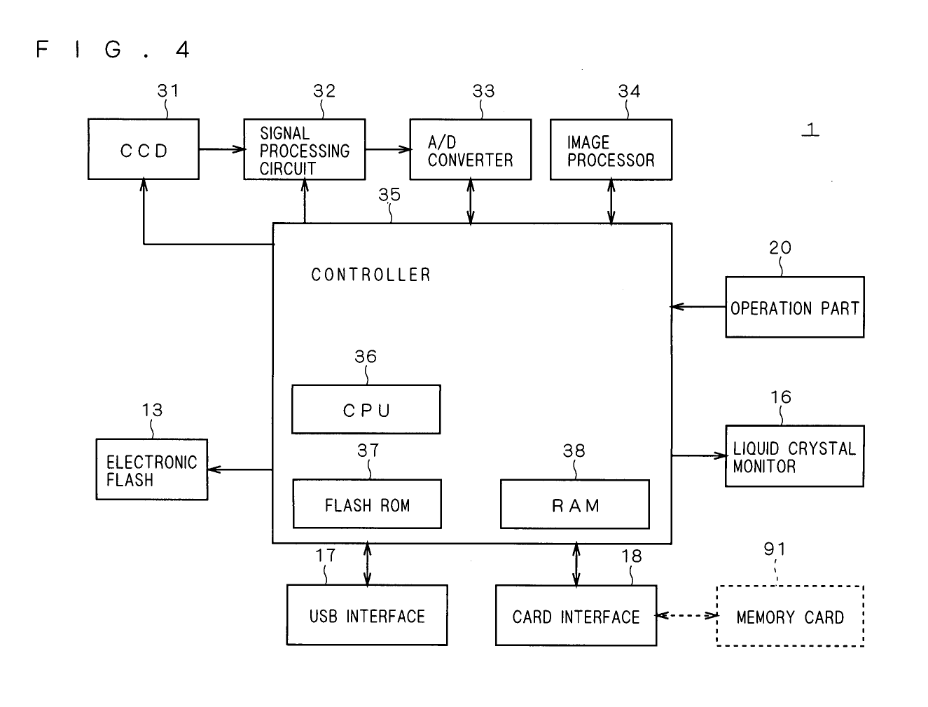

Next, description will be given of a configuration of the digital camera 1. FIGS. 2 and 3 are perspective views each showing an appearance configuration of the digital camera 1. FIG. 2 illustrates a front side of the digital camera 1 and FIG. 3 illustrates a rear side thereof.

As shown in FIG. 2, a taking lens 11, an objective window of an optical viewfinder 12, and an electronic flash 13 are provided on the front side of the digital camera 1. The taking lens 11 is constituted of a plurality of lens units.

A main switch 21 for switching between power-on and power-off and a shutter start button 22 for accepting an image capturing instruction by a user are disposed on an upper side of the digital camera 1. Hereinafter, an image of a subject, which is acquired in accordance with an image capturing instruction by the shutter start button 22, is referred to as a “captured image”.

A cover 14 which can be freely opened/closed is provided on a side of the digital camera 1. A card slot 15 is formed inside the cover 14. The memory card 91 for recording the captured image can be inserted into the card slot 15.

As shown in FIG. 3, an eyepiece window of the optical viewfinder 12, a liquid crystal monitor 16 for displaying various kinds of information, as well as a mode switching button 23, a cross cursor button 24, a printing button 25 and function button group 26 each of which is an operation member for accepting a user operation are provided on the rear side of the digital camera 1.

The liquid crystal monitor 16 displays various kinds of information such as the captured image recorded in the memory card 91 and a setting menu for setting various settings of the digital camera 1. In an image capturing standby state, a live-view image indicative of an almost real-time state of a subject is displayed on the liquid crystal monitor 16. The user can utilize the liquid crystal monitor 16 as a viewfinder.

The mode switching button 23 and the printing button 25 are utilized for switching an operation mode of the digital camera 1. The digital camera 1 has an “image capturing mode”, a “reproduction mode” and a “print mode” as the operation mode.

The “image capturing mode” is an operation mode for acquiring the captured image to record in the memory card 91, and the “reproduction mode” is an operation mode for reproducing and displaying the captured image recorded in the memory card 91. The “print mode” is an operation mode for performing a process regarding printing of the captured image recorded in the memory card 91, such as setting of the number of prints and the print size. A predetermined operation is performed in the “print mode”, so that an auto-print file which is in conformity with DPOF (R) standards is created in the memory card 91. The auto-print file is a file in which printing conditions such as the number of prints and the print size of the captured image recorded in the memory card 91 are written. The auto-print file is utilized by the printer 4 which prints the captured image. In the first preferred embodiment, one of “L-size” and “2L-size” is set as the print size.

When the mode switching button 23 is depressed in the “image capturing mode” and the “reproduction mode”, an operation mode is switched between the “image capturing mode” and the “reproduction mode”. On the other hand, when the printing button 25 is depressed in the “image capturing mode” and the “reproduction mode”, an operation mode is switched to the “print mode”. In addition, when the mode switching button 23 is depressed in the “print mode”, an operation mode returns to an operation mode (the “image capturing mode” or the “reproduction mode”) prior to switch to the “print mode”. On the other hand, when the printing button 25 is depressed in the “print mode”, an operation mode is maintained as the “print mode”. That is, when the printing button 25 is depressed, an operation mode is the “print mode” even in the case where the operation mode is any one of the three modes. Therefore, the user can promptly switch an operation mode to the “print mode” and can easily create an auto-print file.

The cross cursor button 24 is mainly used for various setting operations and is constituted by an up button 24u, a down button 24d, a left button 24l, a right button 24r and a determination button 24c. The function button group 26 is a function button group to which functions are dynamically allocated in accordance with operation states of the digital camera 1, and is constituted from three buttons of a first button 26a, a second button 26b and a third button 26c. The first button 26a is mainly utilized as a button for allowing the liquid crystal monitor 16 to display a setting menu. The second button 26b is mainly utilized as a button for changing a display state of the liquid crystal monitor 16. The third button 26c is mainly utilized as a button for switching setting of the electronic flash 13 between light emission and no light emission.

A USB interface 17, which is in conformity with USB standards, for establishing data communication with other external devices is disposed on a side of the digital camera 1 opposite to the side on which the cover 14 is disposed.

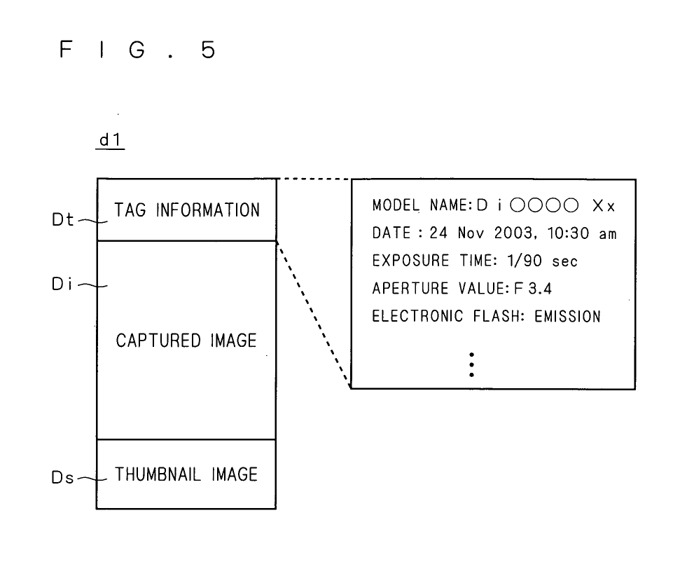

FIG. 4 is a functional block diagram showing a main internal configuration of the digital camera 1. As shown in FIG. 4, the digital camera 1 includes a controller 35 which controls the entirety of the apparatus in a centralized manner. The controller 35 is constituted to have a microcomputer. The controller 35 also has: a CPU 36 for performing various computation processes; a rewritable flash ROM 37 for storing a control program, data and the like; and a RAM 38 utilized for a working area of computation. Each processor of the digital camera 1 is electrically connected to the controller 35 and operates under control of the controller 35.

A CCD 31 is an image capturing device for capturing an image of a subject, and includes a photo reception part for photoelectrically converting an optical image of the subject formed by the taking lens 11 into a signal charge (image signal), and a transfer part for transferring the signal charge. The photo reception part is composed of a plurality of pixels to which any one of color filters of R (red), G (green) and B (blue) is adhered. The signal charge accumulated in each pixel of the photo reception part is read out, and transferred and outputted by the transfer part.

A signal processing circuit 32 includes a CDS (Correlated Double Sampling) circuit and an AGC (Automatic Gain Control) circuit, and performs a predetermined analog signal process on the image outputted from the CCD 31. An A/D converter 33 converts the image of the analog signal outputted from the signal processing circuit 32 into an image of a digital signal. An image processor 34 performs various imaging processes such as a color component interpolating process, a white balance correcting process, a y correcting process, a resolution converting process and a compression process.

After the signal processing circuit 32 and the A/D converter 33 perform predetermined processes on the image acquired by the CCD 31 in response to the operation of the shutter start button 22, the image is stored in the RAM 38 of the controller 35. The image stored in the RAM 38 is further subjected to various imaging processes by the image processor 34. As a result of imaging processes by the image processor 34, the captured image compressed to be recorded in the memory card 91 is generated. The generated captured image is recorded in the memory card 91 as an image file of Exif (Exchangeable Image File Format) by the controller 35.

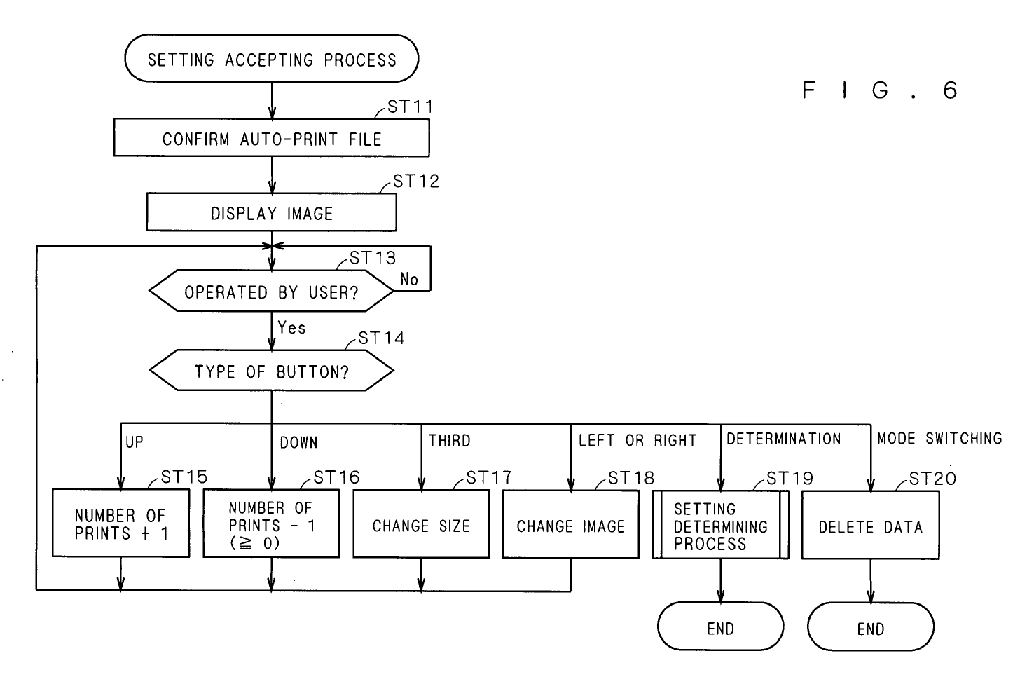

FIG. 5 illustrates an example of an image file of Exif. As shown in FIG. 5, an image file d1 is constituted from a tag information part Dt, an image main body part Di and a thumbnail image part Ds. The captured image itself is stored in the image main body part Di, and a thumbnail image of same content as the captured image having relatively low resolution is stored in the thumbnail image part Ds. The tag information part Dt stores various information for describing the captured image. In the first preferred embodiment, the tag information includes a “model name”, a “date”, an “exposure time” and an “aperture value”. Herein, the “model name” is the identification information indicative of the type of a digital camera.

With reference to FIG. 4 again, a card interface 18 writes or reads data in the memory card 91 inserted into the card slot 15. The card interface 18 is electrically connected to the controller 35, and writes or reads the captured image on the basis of the signal from the controller 35.

An operation part 20 shows the above operation members such as the shutter start button 22, the mode switching button 23, the cross cursor button 24, the printing button 25 and the function button group 26 as one functional block. The user operation accepted in the operation part 20 is inputted into the controller 35 as a signal. As a result, switching of an operation mode and other operation controls corresponding to the user operation can be executed by the controller 35. The electronic flash 13, the liquid crystal monitor 16 and the USB interface 17 are also electrically connected to the controller 35, and operate under control of the controller 35.

Various functions of the controller 35 can be executed by a computation operation by the CPU 36 in accordance with the control program stored in the flash ROM 37. Such control program is stored in the flash ROM 37 in advance, but it is also possible to store a new control program being read out from the memory card 91 or the like in the flash ROM 37.

Functions of the controller 35 realized by computation of the CPU 36 in accordance with the above control program include, in addition to the operation control functions of the above parts of the digital camera 1, a function of determining exposure conditions such as an aperture value and an exposure time, a function of determining a focusing position of the taking lens 11, a function of creating an image file of the captured image and recording in the memory card 91, and a function of process relating to printing. The process relating to printing is, typically, the setting accepting process of accepting setting of printing conditions such as the number of prints and the print size from the user.

1-3. Setting Accepting Process

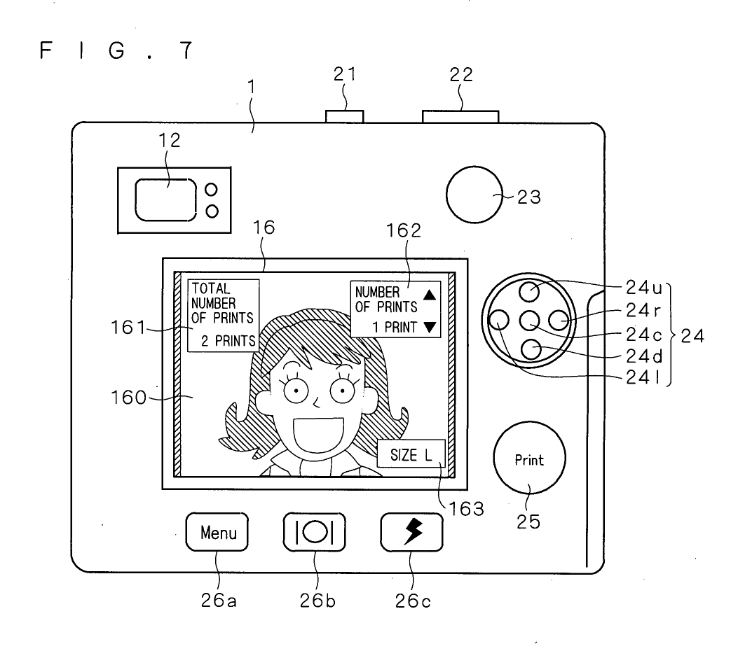

Herein, description will be given of the setting accepting process. FIG. 6 is a flowchart of the setting accepting process. This process starts when the operation mode of the digital camera 1 is set in the “print mode”.

First, the auto-print file in the memory card 91 is confirmed. When the auto-print file is present, the printing conditions (the number of prints and the print size) of each captured image recorded in the auto-print file is read out, and stored as data in the RAM 38. On the other hand, when the auto-print file is not present, the printing conditions of all captured images is provisionally set in default values, and stored as data in the RAM 38. In the first preferred embodiment, the default value of the number of prints is “0” and the default value of the print size is “L-size” (step ST11).

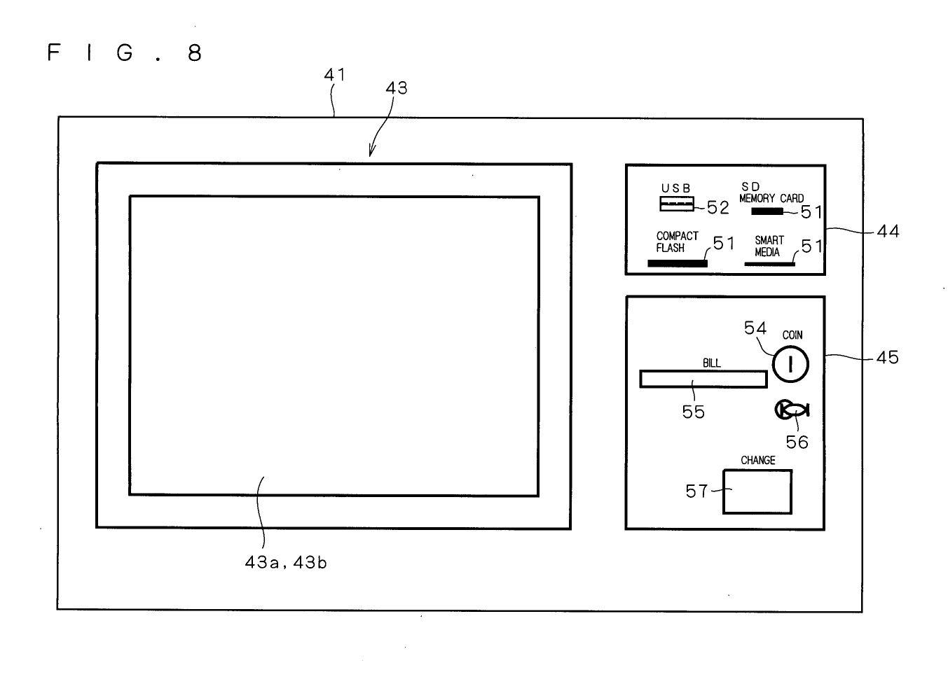

The latest captured image is displayed on the screen of the liquid crystal monitor 16. FIG. 7 illustrates a screen display example of the liquid crystal monitor 16. As shown in FIG. 7, one captured image 160 is displayed on the screen of the liquid crystal monitor 16. At the same time, the printing conditions are shown in overlap with the captured image 160. More specifically, the upper left corner of the screen displays the total number of prints 161 as the total number of prints set in each captured image in the memory card 91, the upper right corner of the screen shows the number of prints 162 set in the captured image being displayed on the screen, and the lower right corner of the screen close to the third button 26c shows the print size 163 set in the captured image being displayed on the screen (step ST12).

After such display, the digital camera 1 turns into a waiting state for an user operation through the operation part 20 (step ST13). When the user operates, the process corresponding to the operation is performed (steps ST14 to ST20).

When the up button 24u is depressed, the number of prints of the captured image being displayed is increased by “1” (step ST15). When the down button 24d is depressed, the number of prints of the captured image being displayed is decreased by “1” as long as the number of prints is not negative (step ST16). When the third button 26c is depressed, the print size of the captured image being displayed is changed between the “L-size” and the “2L-size” (step ST17).

When the left button 24l or the right button 24r is depressed, the captured images displayed on the liquid crystal monitor 16 are changed sequentially. That is, the previous captured image is displayed when the left button 24l is depressed, and the subsequent captured image is displayed when the right button 24r is depressed (step ST18). Therefore, while changing the captured image by the left and right buttons 24l, 24r, the user can operate the up and down buttons 24u, 24d and third button 26c, and can set the desired number of prints and the desired print size of the desired captured image.

Change of the printing conditions (the number of prints and the print size) by such operation is effected on the data in the RAM 38 alone, and the change is not reflected in the auto-print file. It is reflected in the auto-print file when the determination button 24c is depressed. That is, when the determination button 24c is depressed, a setting determining process is performed, and the content of the printing conditions stored as data in the RAM 38 is written in the auto-print file. As a result, the printing conditions are established and the setting accepting process is finished. In the setting determining process, when the auto-print file is not present in the memory card 91, an auto-print file is created (step ST19).

When the mode switching button is depressed, the data of the printing conditions in the RAM 38 is deleted, and the setting accepting process is finished. The operation mode proceeds to the “image capturing mode” or the “reproduction mode” (step ST20).

1-4. Configuration of Printer

Next, description will be given of a configuration of the printer 4. As shown in FIG. 1, the printer 4 has a housing 40 in a shape of assembling two boxes, a large one and a small one, an operation panel 41 functioning as a user interface is disposed on an upper portion of a front side of the housing 40, and a photograph outlet 42 for taking out a print (hereinafter, referred to as a “photograph”) of a digital image is formed in a lower portion of the front side of the housing 40.

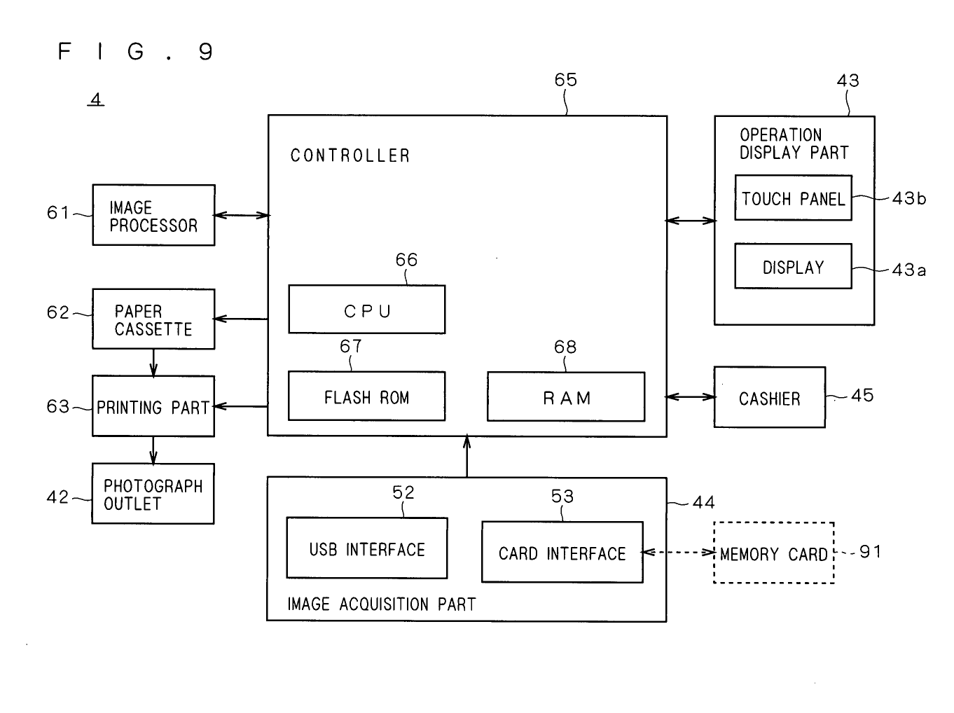

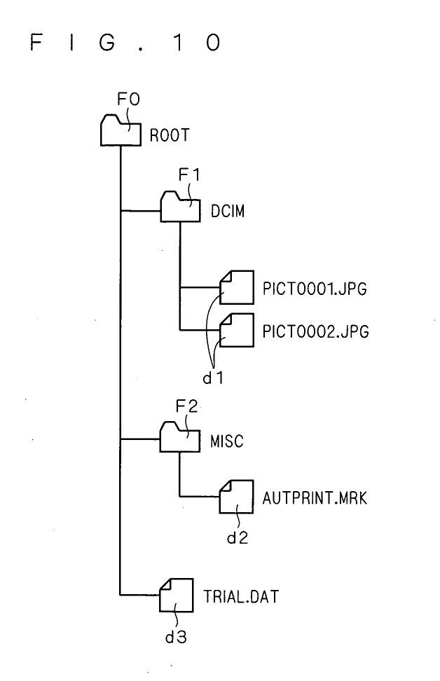

FIG. 8 is an enlarged view of the operation panel 41, and FIG. 9 is a functional block diagram showing a main internal configuration of the printer 4.

As shown in FIG. 8, the operation panel 41 has an operation display part 43 for displaying various information and accepting the user operation, an image acquisition part 44 for acquiring a digital image to be printed, and a cashier 45 for receiving a service charge for a printing service from the user.

The operation display part 43 has a configuration in that a transparent touch panel 43b capable of recognizing a pressed position is disposed on a screen of a display 43a such as CRT (see FIG. 9). The user refers to a guide message displayed on the screen of the operation display part 43, and directly touches the command buttons displayed on the screen, so that various instructions are given to the printer 4 in an interactive manner.

The image acquisition part 44 has a card slot 51 into which a memory card can be inserted, and a USB interface 52, which is conformity with USB standards, for establish data communication with other external devices. The card slot 51 has a card interface 53 (see FIG. 9), and an image stored in the memory card can be read. The card slot 51 is available in plural types in accordance with various standards so as to insert memory cards of various standards thereinto, and the memory card 91 of the digital camera 1 can be also inserted. Usually, the image acquisition part 44 acquires an image from the memory card inserted into the card slot 51, but an image can be also acquired from the memory device provided in other external device through the USB interface 52.

The cashier 45 has a coin inlet 54, a bill insert 55, a return lever 56 and a coin return port 57. In the printer 4, when a service charge for operation is required, the display 43a of the operation display part 43 shows a display urging to pay a charge. When this display appears, the operation of the printer 4 pauses, and when the reception of the charge is confirmed by the cashier 45, the interrupted operation is resumed.

Further, as shown in FIG. 9, the printer 4 also includes a controller 65 which controls entirety of the apparatus in a centralized manner. The controller 65 is constituted to have a microcomputer. The controller 65 also has: a CPU 66 for performing various computation processes; a rewritable flash ROM 67 storing a control program, data and the like; and a RAM 68 used as a working area of computation.

The operation display part 43 (including the display 43a and the touch panel 43b), the image acquisition part 44 (including the card interface 53 and the USB interface 52), and the cashier 45 are electrically connected to the controller 65. As a result, a user operation through the touch panel 43b of the operation display part 43, an image acquired in the image acquisition part 44 and the amount entered in the cashier 45 are inputted into the controller 65. The display of the display 43a of the operation display part 43 is controlled by the controller 65.

The controller 65 is also connected to an image processor 61, a paper cassette 62 and a printing part 63. The image processor 61 performs various imaging processes such as an extension process and a gradation correcting process on an image to be printed. The paper cassette 62 holds printing papers in two sizes of the “2L-size” and the “2L-size” and the printing paper of the size designated by the signal from the controller 65 is supplied to the printing part 63. The printing part 63 prints the image in color on the printing paper supplied from the paper cassette 62, produces a photograph, and discharges this photograph into the photograph outlet 42. Therefore, the printing part 63 produces a photograph in one of the “L-size” and the “L2-size”. The printing method of the printing part 63 adapts, for example, a sublimation type thermal transfer method. The number of prints and print size of the captured image to be printed by the printing part 63 are set by the controller 65 on the basis of the auto-print file in the memory card 91 recording the captured image.

The image acquired from the memory card 91 by the image acquisition part 44 is first stored in the RAM 68 of the controller 65. The image stored in the RAM 68 is subjected to various imaging processes by the image processor 61, and data for printing of a predetermined format suitable for printing is generated. On the basis of the data for printing, the printing part 63 prints and produces a photograph.

Various functions of the controller 65 are realized by the CPU 66 performing computation processes in accordance with the control program stored in the flash ROM 67. Such control program is stored in the flash ROM 67 in advance, but a new control program may be read out from the memory card 91 and stored in the flash ROM 67.

Functions of the controller 65 realized by such computation by the CPU 66 in accordance with the control program include, in addition to the operation control functions of the above parts of the printer 4, various functions such as a function of a process relating to printing, and a function of determining the “application mode” and operating and controlling in accordance with the “application mode”. The process relating to printing is, typically, the process of setting the number of prints and the print size of actual printing the captured image on the basis of the auto-print file.

Herein, the “application mode” is a mode regarding the purpose of use by the user, and includes a “normal mode” for providing a printing service by collecting the corresponding charge from the customer, and a “trial use mode” for allowing the customer to experience the image acquiring/printing process. The operation of the printer 4 differs between the “normal mode” and “trial use mode”. The application mode is determined by the memory card inserted into the card slot 51.

1-5. Memory Card

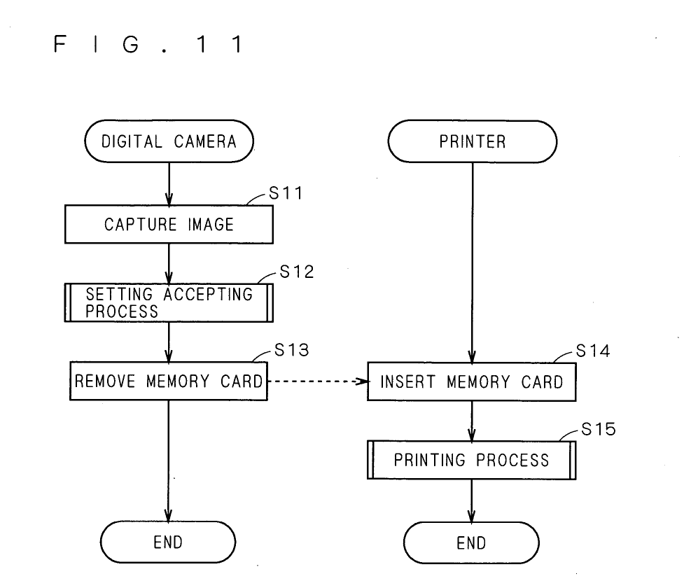

FIG. 10 illustrates a data configuration example in the memory card 91 used in the first preferred embodiment. As shown in FIG. 10, the data storage structure in the memory card 91 adapts a hierarchical folder structure (hierarchical directory structure), and data is stored in folders F0 to F2 in the hierarchical folder structure. In FIG. 10, character strings shown at the side of the data d1 to d3 in the folders F0 to F2 indicate the names of corresponding folders F0 to F2 and data d1 to d3.

As shown in FIG. 10, the highest layer of the hierarchical folder structure includes a “root” folder F0, and this “root” folder includes a “DCIM” folder F1 and an “MISC” folder F2 as sub holders. The image file dl including the captured images acquired by the digital camera 1 is stored in the “DCIM” folder F1, and the auto-print file (AUTPRINT.MRK) d2 is stored in the “MISC” folder F2.

When the memory card 91 is a memory card for trial use for experiencing the image acquiring/printing process, as shown in FIG. 10, a trial use identification file (TRIAL.DAT) d3 indicative of a memory card for trial use is stored in the “root” folder F0. The trial use identification file d3 has a concealed file attribute, and its existence is not recognized by general users. In the printer 4, depending on the presence/absence of the trial use identification file d3 in the inserted memory card 91, the application mode is determined. Instead of determination of the application mode by the presence/absence of the trial use identification file d3, the application mode may be determined by the data of specified address in the memory card 91.

1-6. Image Acquiring/Printing Process

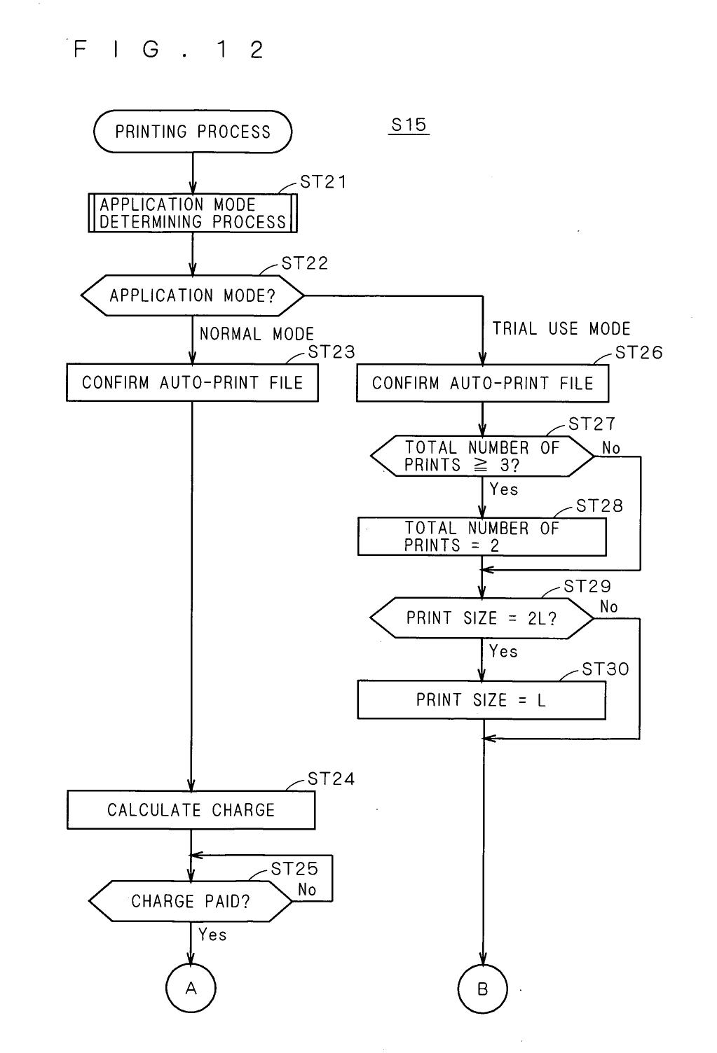

Next, description will be given of the image acquiring/printing process using the printing system 101. FIG. 11 is a flowchart basically showing the image acquiring/printing process. Upon start of this process, the memory card 91 is inserted into the digital camera 1.

The operation mode of the digital camera 1 is set to the “image capturing mode”, and an image is captured by the digital camera 1. The captured image is recorded in the memory card 91. When image capturing is repeatedly performed, plural captured images are recorded in the memory card 91 (step S11).

The operation mode of the digital camera 1 is set to the “print mode”, and the above setting accepting process is performed. As a result, the number of prints and the print size are set for each captured image in the memory card 91, and an auto-print file is created in the memory card 91 (step S12).

Subsequently, the memory card 91 is removed from the digital camera 1 (step S13), and the memory card 91 is inserted into the printer 4 (step S14). As the memory card 91 is inserted, the printer 4 performs a printing process in which the captured images in the memory card 91 are printed in accordance with the printing conditions written in the auto-print file (step S15). Thus, the image acquiring/printing process is finished.

The flow of the image acquiring/printing process in the case of trial use that customers in a shop experience the image acquiring/printing process is almost similar to that in the case of non-trial use. However, in the case of trial use, in order to give easy experience to the customers in the shop, a part of the image acquiring/printing process differs from that in the case of non-trial use. In the first preferred embodiment, the content of the printing process (step ST15) of the printer 4 is changed. Hereinafter, description will be given of the printing process.

1-7. Printing Process

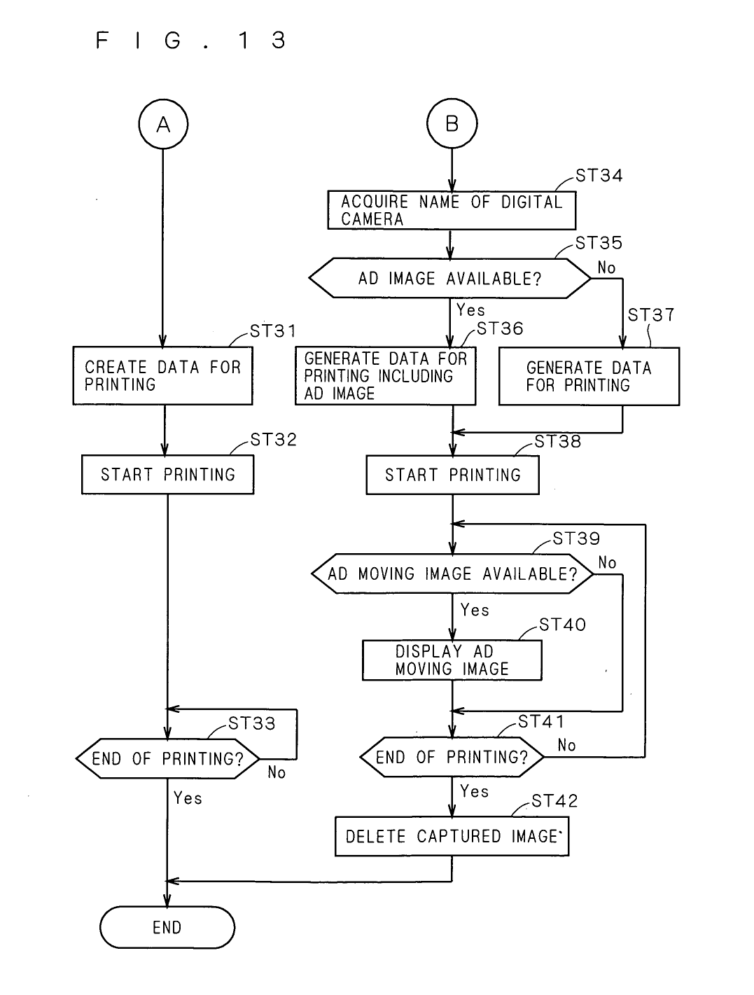

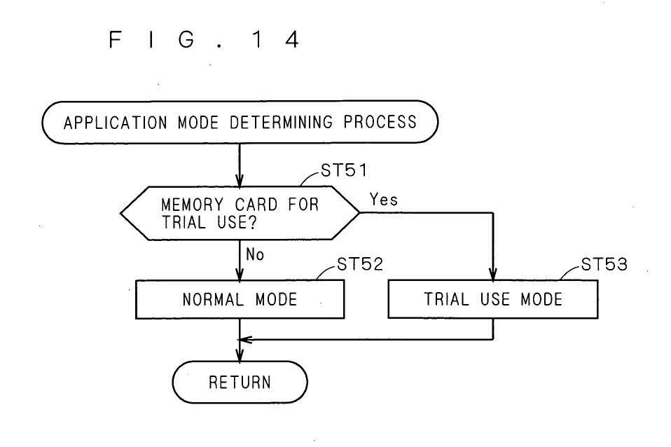

FIGS. 12 and 13 are flowcharts each showing the printing process. In the printing process, first, an application mode determining process in which the application mode is determined is performed (step ST21).

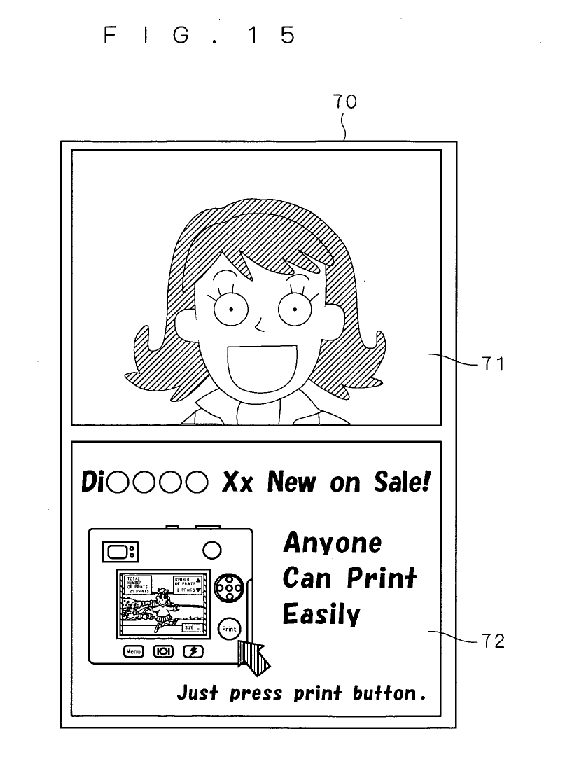

FIG. 14 is a flowchart showing the application mode determining process. In the inserted memory card 91, the presence/absence of the trial use file d3 is confirmed. As a result, it is determined whether the inserted memory card 91 is a memory card for trial use or not (step ST51). When the memory card 91 is not a memory card for trial use, the application mode is determined to be the “normal mode” (step ST52). When the memory card 91 is a memory card for trial use, the application mode is determined to be “trial use mode” (step ST53).

With reference to FIG. 12 again, after the application mode determining process, the process in accordance with the application mode is performed (step ST22).

In the “normal mode”, the auto-print file in the inserted memory card 91 is confirmed. That is, the printing conditions (the number of prints and the print size) of each captured image written in the auto-print file is read out. As long as the total number of prints being read out is within a predetermined maximum permissive number (e.g., “99”), the number of prints of each captured image is set as the actual number of prints of the captured image (hereinafter, referred to as “the actual number of prints”). The print size of each captured image is set as the size of actually printing the captured image (hereafter, referred to as “actual print size”) (step ST23).

On the basis of the set actual number of prints and actual print size, the amount of charge is calculated as payment for a printing service (step ST24). The calculated amount is shown on the display 43a, and the process waits payment of the amount by the user (step ST25).

When the payment of the amount is confirmed in the cashier 45, the process proceeds to step ST31 in FIG. 13, and data for printing is generated on the basis of the actual number of prints and the actual print size of the captured image. The generated data for printing is inputted into the printing part 63, and printing starts, and a photograph is produced (step ST32). When all the intended captured images are printed, printing by the printing part 63 is finished (step ST33), and the printing process is finished.

On the other hand, in the “trial use mode”, first, the auto-print file in the inserted memory card 91 is confirmed, and the printing conditions of each captured image written in the auto-print file is read out (step ST26).

Next, it is determined whether or not the total number of prints of the captured image being read out is equal to or more than “3”. When the total number is less than “3”, the number of prints of the auto-print file is set as the actual number of prints (No in step ST27). If the total number is 3 or more (Yes in step ST27), the first two images of the captured images being set for printing in the auto-print file are set to be printed. That is, in the “trial use mode”, the total number of the actual number of prints of the captured image that can be set is limited to the reference number “2” or less (that is, a predetermined number smaller than the maximum permissive number permitted in the “normal mode”) (step ST28).

Next, the print size of the captured image is confirmed. If the print size is the “2L-size” (Yes in step ST29), the actual print size of the captured image is set at the “L-size”. That is, in the “trial use mode”, the allowable actual print size is limited to the “L-size”, that is, the reference size (that is, a size smaller than the maximum permissive size of the “2L-size” in the “normal mode”) (step ST30).

Referring then to the tag information attached to the captured image to be printed, the name (model name) of the digital camera is obtained (FIG. 13; step ST34). In succession, on the basis of the obtained name of the digital camera, if it checked if an ad image of the digital camera is present in the flash ROM 67 or not (step ST35). The ad image is publicity information describing the features of the digital camera and the method of use. The ad image of each digital camera is preliminarily stored in the flash ROM 67.

If the ad image of the digital camera capturing the image is present in the flash ROM 67, this ad image is obtained from the flash ROM 67. The ad image is added to the captured image, and data for printing is generated. That is, the data for printing include the captured image and the ad image (step ST36). On the other hand, if the ad image of the digital camera capturing the image is not present in the flash ROM 67, the data for printing is generated only from the captured image (step ST37).

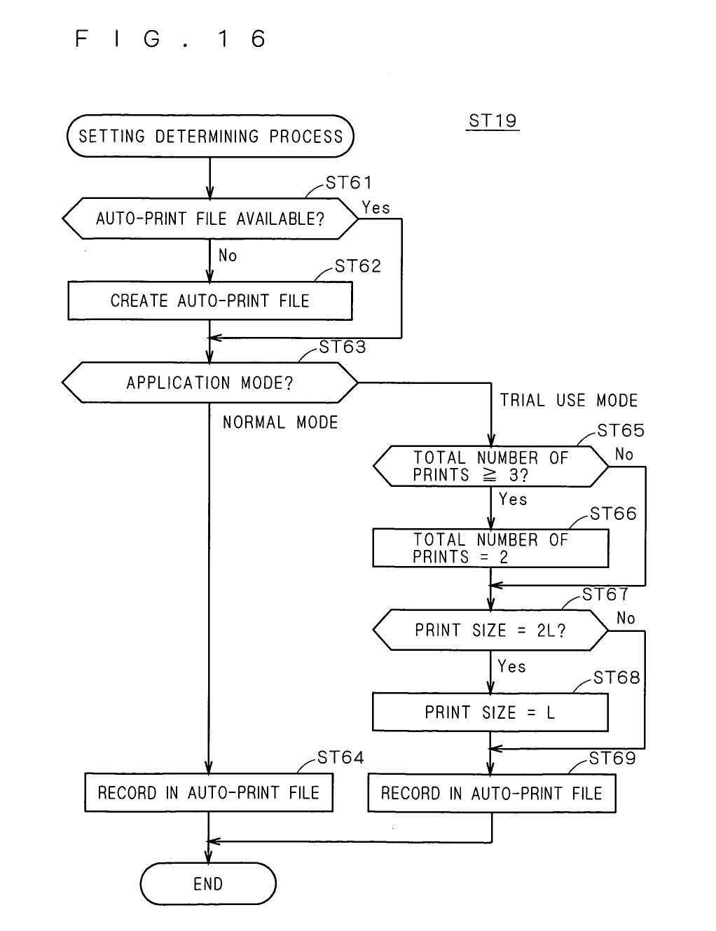

When the data for printing is generated, the generated data is put into the printing part 63, and printing is started, and a photograph is produced (step ST38). FIG. 15 is an example of photograph produced on the basis of the data for printing including the captured image and the ad image. As shown in the diagram, a captured image 71 is disposed in the upper part of the photograph 70, and an ad image 72 is shown in the lower part of the photograph 70. By disposing not only the captured image 71 but also the ad image 72 in the reprinting result of the photograph 70, the features and handling method of the digital camera 1 can be effectively provided to the customer experiencing the image acquiring/printing process.

Back to FIG. 13, printing by the printing part 63 continues until printing of all desired captured images is complete (No in step ST41), and during this printing, if there is an ad moving image about the digital camera capturing the image is present (step ST39), the ad moving image is displayed on the display 43a (step ST40).

The ad moving image is publicity information describing the features and method of use of the digital camera by animation or moving picture, and the ad moving image of each digital camera is preliminarily stored in the flash ROM 67. Like the ad image, the ad moving image is specified by each digital camera capturing the image according to the name of the digital camera obtained from the tag information, and is obtained from the flash ROM 67. By displaying such ad moving image during the printing, the features of the digital camera are described effectively to the customer while experiencing the image acquiring/printing process, and the understanding of the digital camera can be deepened.

When printing is finished (Yes in step ST41), the printing process is terminated, but in the case of the “trial use mode”, immediately before the end of the printing process, the captured image stored in the memory card 91 is deleted (step ST42). In the “trial use mode”, the memory card 91 is an exclusive memory card for trial use, and by deleting the captured image, the storage capacity is maintained, and lack of storage capacity is avoided when a next customer comes to use. Further, the leak of information of the captured image by the previous customer is prevented, and the privacy of customers is protected, so that the customers can use safely.

As described in the first preferred embodiment, in the printing system 101 of the preferred embodiment, the printer 4 has the “normal mode” and “trial use mode” as the application mode, and the printing process of the printer 4 differs between the “normal mode” and “trial use mode”, and the process is suited to trial use in the “trial use mode”. Hence, the customer can easily experience the function about printing of captured image of the printing system 101.

More specifically, in the “trial use mode”, the allowable actual number of prints is set to the reference number “2” or less, and the allowable actual print size is limited to the reference size of the “L-size”, and the allowable printing condition is limited as compared with the “normal mode”. Accordingly, during trial use, printing of too many prints or larger print size due to errors of customers not familiar with the operation can be avoided. If printing of too many prints or larger print size occurs, the trial time by one customer is very long, and many customers cannot experience, and such inconvenience can be avoided.

Also in the “trial use mode”, data for printing on the basis of the captured image and the ad image is formed, and the ad image of the digital camera capturing the image is printed together with the captured image. During printing in the “trial use mode”, moreover, the ad moving image of the digital camera capturing the image is displayed. Therefore, the description information of the digital camera can be effectively provided to the customer.

2. Second Preferred Embodiment

A second preferred embodiment of the present invention will be described. The configuration of the printing system of the preferred embodiment is same as in the first preferred embodiment. What differs from the first preferred embodiment is as follows: in the first preferred embodiment, only the printer 4 has the two application modes, the “normal mode” and “trial use mode”, while this preferred embodiment features that the digital camera 1 also has the two application modes, the “normal mode” and “trial use mode”, and is hence difference in processing contents between the “normal mode” and “trial use mode”. Mainly the different points from the first preferred embodiment are narrated below.

In the digital camera 1 of this preferred embodiment, as one of the initialization processes when turning on the power, the application mode is determined. The flow of this application mode determining process is same as shown in FIG. 14. That is, presence or absence of the trial use identification file d3 in the memory card 91 loaded in the digital camera 1 is checked (step ST51), and if it is not an exclusive memory card for trial use, the application mode is determined to be “normal mode” (step ST52), or in the case of an exclusive memory card for trial use, the application mode is determined to be “trial use mode” (step ST53).

A basic flow of image acquiring/printing process in this preferred embodiment is same as shown in FIG. 11. In this preferred embodiment, however, together with the content of printing process (step S15) of the printer 4, the content of setting accepting process (step S12) of the digital camera 1 is different between the ordinary use and trial use. The printing process of the printer 4 is same as in the first preferred embodiment.

The setting accepting process of the digital camera 1 in this preferred embodiment will be described. In the preferred embodiment, too, the basic flow of setting accepting process is same as shown in FIG. 6, except that the content of setting determining process (step ST19) is different from that in the first preferred embodiment.

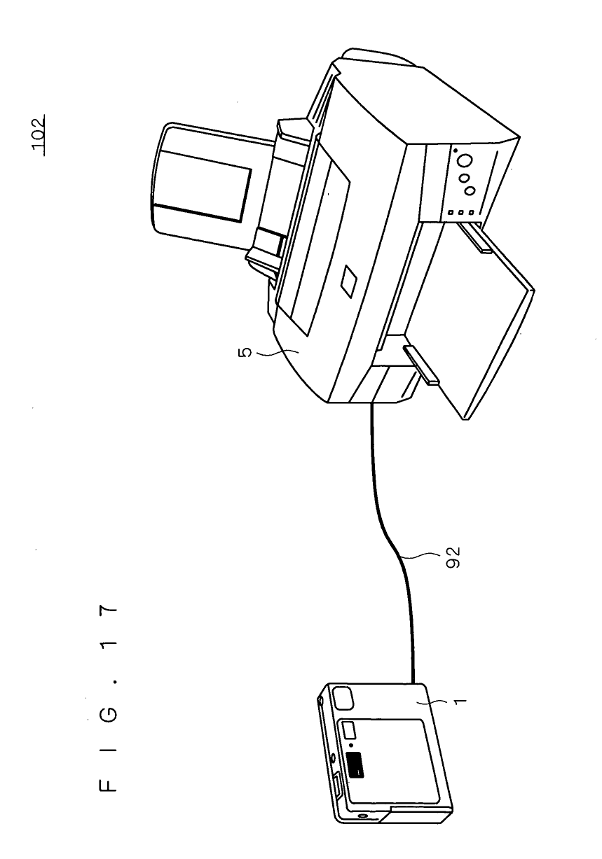

FIG. 16 is a diagram showing flow of setting determining process in the preferred embodiment. First it is checked if auto-print file is present or not in the memory card 91 (step ST61), and if automatic print card is not present, an auto-print file is created (step ST62). Thereafter, the process is executed according to the application mode (step ST63).

In the “normal mode”, as far as the total number of prints of printing of captured images is within the specified maximum permissive number (e.g., “99”), the number of prints of the captured images and the print size stored as data in the RAM 38 are directly specified in the auto-print file (step ST64), and the setting determining process is terminated.

On the other hand, in the “trial use mode”, the total number of prints of printing the captured image stored as data in the RAM 38 is checked, and it is determined whether or not the total number is equal to or more than “3” (step S69). If the total number is 3 or more, the data in the RAM 38 is changed such that the first two images out of the captured images being set for printing by the user are allowed to be printed (step S66).

Next, the print size of the captured image stored as data in the RAM 38 is confirmed. If the print size is the “2L-size” (step ST67), the print size of the captured image is changed to the “L-size” (step ST68).

In succession, the number of prints and print size of the captured images stored in the RAM 38 are written into the auto-print file (step ST69), and the setting determining process is finished. That is, in the “trial use mode”, the total number of prints of the captured images that can be set is limited to the reference number “2” or less (that is, a predetermined number smaller than the maximum permissive number permitted in the “normal mode”), and the allowable print size is limited to the “L-size”, that is, the reference size to be printed (that is, a size smaller than the maximum permissive size of the “2L-size” in the “normal mode”).

Thus, in the second preferred embodiment, the digital camera 1 also as the application modes of “normal mode” and “trial use mode”, and the processing about printing of the digital camera 1 differs between the “normal mode” and “trial use mode”, and the process is suited to trial use in the “trial use mode”. In this preferred embodiment, too, the customer can easily experience the function about printing of captured image of the printing system 101.

More specifically, the limited printing condition (number of prints and print size) in the printer 4 in the first preferred embodiment is also limited in the digital camera 1. In this manner, same as in the first preferred embodiment, printing of excessive number of prints or large print size in the trial use can be prevented. In this preferred embodiment, since the printing condition is limited at the digital camera 1 side, processing in steps ST27 to ST30 in FIG. 12 can be skipped in the printing process of the printer 4.

3. Third Preferred Embodiment

A third preferred embodiment will be described. In the foregoing preferred embodiments, it is supposed to be printed by a self-printer, but in this preferred embodiment, it is intended to be printed by a general consumer-use printer.

3-1. Overview of Printing System

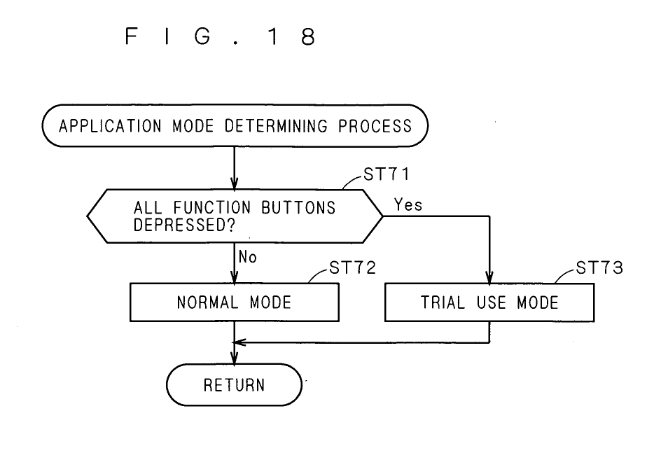

FIG. 17 is a diagram showing a printing system of this preferred embodiment. A shown in the drawing, a printing system 102 comprises a digital camera 1 and a consumer printer 5. The digital camera 1 and printer 5 conform, for example, to PictBridge standard, and by transmitting the signals about various printings from the digital camera 1 to the printer 5 through a USB cable 92, the captured images obtained in the digital camera 1 can be directly printed by the printer 5.

The structure of the digital camera is same as shown in FIG. 2 or FIG. 4. The USB cable 92 is connected to the USB interface 17. That is, the digital camera 1 can communicate with the printer 5 through the USB interface 17, and the captured image to be printed is transmitted from the digital camera 1 to the printer 5.

The digital camera 1 of this preferred embodiment has the “normal mode” and “trial use mode” as the application modes same as in the second preferred embodiment, and the processing content differs between the “normal mode” and “trial use mode”.

In the digital camera 1, the captured image can be recorded not only in the memory card 91 but also in the flash ROM 37 which is a built-in memory. By the control of the controller 35, in the “normal mode”, the captured image is recorded in the memory card 91, and in the “trial use mode”, on the other hand, the captured image is recorded only in the flash ROM 37. Therefore, in the “trial use mode”, the captured image can be obtained without loading the memory card 91 into the digital camera 1, and hence loss of the memory card 91 during trial use at the shop counter can be prevented. The auto-print file created in the “trial use mode” is recorded in the flash ROM 37 same as the captured image.

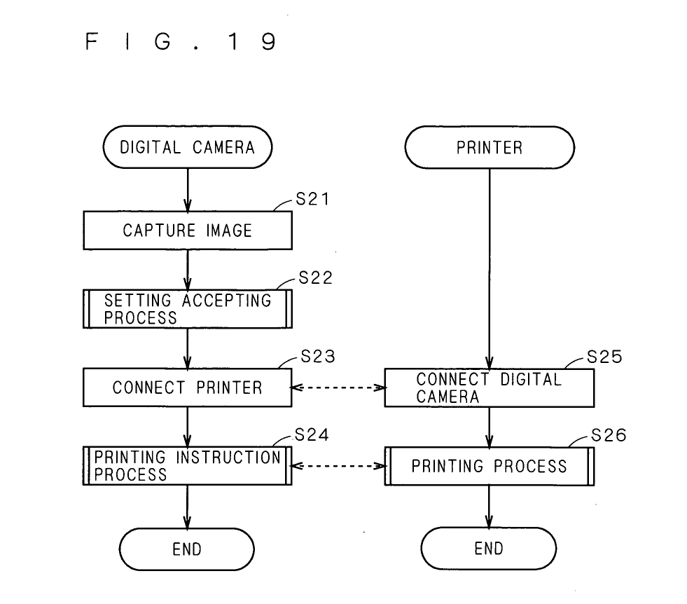

In the digital camera 1 of the preferred embodiment, the application mode determining process is available as one of the initialization processes when turning on the power source. In this preferred embodiment, however, since loading of memory card 91 is not indispensable, the content of the application mode determining process is different from the above preferred embodiment. FIG. 18 is a diagram showing flow of application mode determining process in the preferred embodiment. As shown in the diagram, first, when the power source is turned on, it is determined whether all function buttons 26a to 26c are depressed or not (step ST71). When the function buttons 26a to 26c are not depressed, the application mode is determined to be “normal mode” (step S72), and when all function buttons 26a to 26c are depressed, the application mode is determined to be “trial use mode” (step ST73).

3-2. Image Acquiring/Printing process

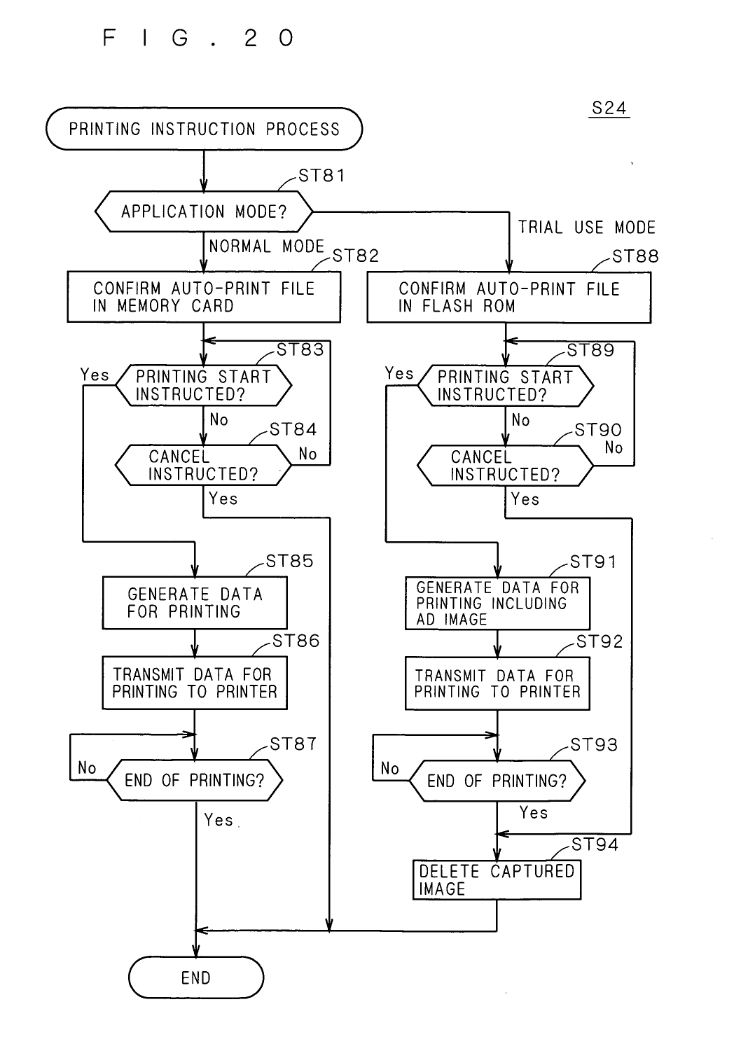

Image acquiring/printing process by using the printing system 102 of the preferred embodiment will be described. FIG. 19 is a diagram showing basic flow of image acquiring/printing process of the preferred embodiment.

First, the operation mode of the digital camera 1 is set in the image capturing mode, and the image is captured by the digital camera 1. The captured image is recorded in the memory card 91 in the “normal mode”, or in the flash ROM 37 in the “trial use mode”. If captured repeatedly, plural captured images are recorded, but in the “trial use mode” if the number of captured images exceeds the reference number, acceptance of tanking instruction by the shutter start button may be prohibited, and the available number of captured images maybe limited with the reference number (step S21).

Next, the operation mode of the digital camera 1 is set in the print mode, and the setting accepting process is executed. In this setting accepting process is same as in the second preferred embodiment. Therefore, in the “trial use mode”, the available printing condition (number of prints and print size) is limited as compared with the “normal mode”. As mentioned above, in the “trial use mode”, the auto-print file is created in the flash ROM 37 (step S22).

When the auto-print file is compiled, a message urging connection with the printer 5 is displayed in the liquid crystal monitor 16 of the digital camera 1, thereby waiting for connection with the printer 5. According to the display, the user connects the digital camera 1 and printer 5 by means of the USB cable 92 (step S23, S25).

The digital camera 1 and printer 5 are connected and are ready to communicate with each other, and the controller 35 of the digital camera 1 performs a printing instruction process for transmitting the data for printing and signal about printing on the basis of the captured image (step S24). In response to such signal from the digital camera 1, the printer 5 performs the printing process in which a photograph as the printed matter of the captured image is produced (step S26). Thus, the image acquiring/printing process is finished.

In this preferred embodiment, between the trial use of the customer at this shop counter for experiencing the image acquiring/printing process (“trial use mode”) and the ordinary operation (“normal mode”), together with the image capturing operation and setting accepting process, the content of the print instruction process (step S24) of the digital camera 1 is different. This print instruction process will be described below.

3-3. Print Instruction Process

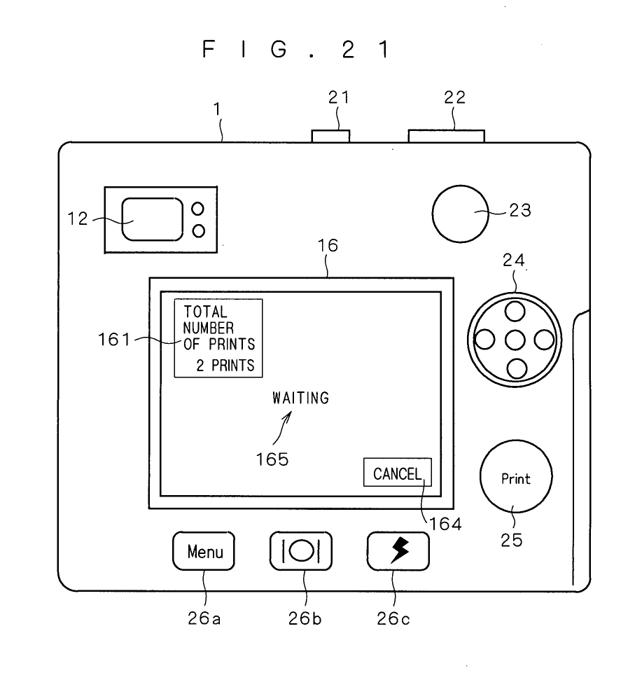

FIG. 20 is a diagram showing flow of print instruction process. In the print instruction process, upon start of process, the application mode is confirmed (step ST81), and the process corresponding to the application mode is executed thereafter.

In the “normal mode”, the auto-print file in the memory card 91 is confirmed. As a result, the printing condition specified in the auto-print file such as the number of prints and print size of each captured image is read out, and the actual number of prints and the actual print size of the captured images are determined and set (step ST82). The process waits for user's instruction for starting printing or canceling printing (step ST83, ST84).

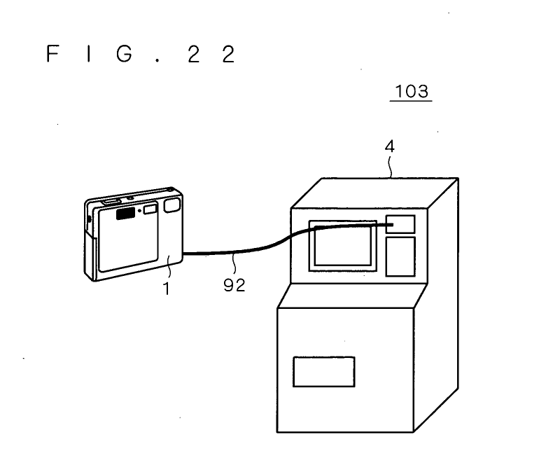

FIG. 21 is a diagram showing a display example of screen of liquid crystal monitor 16 in print instruction process. As shown in the diagram, in the print instruction process, the screen displays a total number 161 of total of number of actual prints of captured images in the upper left corner, a status character string 165 showing the status and printing situation of the printer 5 in the center, and a character string “CANCEL” 164 in the lower right corner of the screen near the third button 26c. In this state, the user gives an instruction to the digital camera 1 so as to start printing by pressing the printing button 25 or cancel printing by pressing the third button 26c.

Back to FIG. 20, when the user instructs to start printing (Yes in step ST83), data for printing is generated from the captured image only on the basis of the actual number of prints and the actual print size of the captured images (step ST85). The generated data for printing is sent to the printer 5 and printing starts, and photographs are produced from the printer 5 (step ST86). The process waits for reception of end signal which is transmitted from the printer 5 when all desired captured images are printed out (step ST87), and when the end signal is received, the print instruction process is terminated. When the user instructs to cancel printing (Yes in step ST84), the print instruction process ends.

On the other hand, in the “trial use mode”, the auto-print file in the flash ROM 37 is checked, and the printing condition specified in the auto-print file such as the number of prints and print size of captured images is read out. The number of prints and print size of the captured images being read out are limited as compared with the “normal mode”, and they are directly set as the actual number of prints and the actual print size (step ST88). The process wait until the user gives an instruction to start printing or cancel printing (step ST89, ST90).

When the user instructs to start printing (Yes in step ST89), data for printing is generated on the basis of the actual number of prints and the actual print size of the captured image. At this time, the data for printing is generated by including the ad image about the digital camera 1 added to the captured image. Therefore, the data for printing includes the captured image and the ad image. This ad image is preliminarily recorded in the flash ROM 37 (step ST91).

In succession, the generated data for printing is sent to the printer 5 and printing starts, and photographs are produced from the printer 5 (step ST92). Since the data for printing includes the captured image and the ad image, the produced photograph shows the ad image together with the captured image same as shown in FIG. 15.

After transmission of data for printing, the digital camera 1 waits for reception of end signal from the printer 5 (step ST93). When the end signal is received, the print instruction process is terminated, but in the case of the “trial use mode”, immediately before the end of the print instruction process, the captured image stored in the flash ROM 37 is deleted (step ST94). As a result, lack of storage capacity of the flash ROM 37 is avoided when a next customer comes for trial use, and the privacy of customers is protected. In the “trial use mode”, if the user instructs to cancel printing (Yes in step ST90), the captured image stored in the flash ROM 37 is deleted immediately before end of print instruction process (step ST94).

As described in the third preferred embodiment, in the printing system 102 of the preferred embodiment, the same process as the trial use at the side of the printer 4 in the first preferred embodiment is also executed at the side of the digital camera 1. Thus, same as in the foregoing preferred embodiments, the customer at the shop counter can easily experience the function about printing of captured images. The printer 5 of this printing system 102 is realized by a general consumer printer, so that the service can be provided at a relatively low cost.

4. Modifications

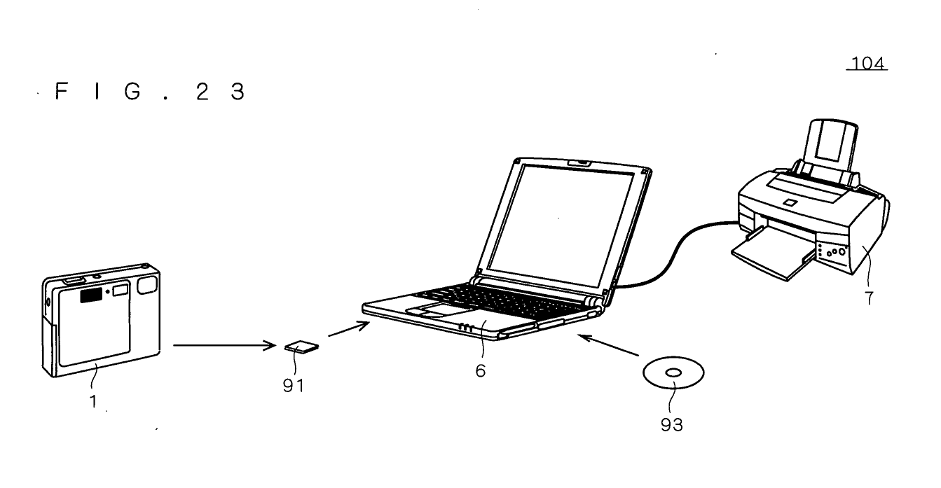

In the first and second preferred embodiments, the memory card 91 is used for exchanging the captured images and auto-print file between the digital camera 1 and the printer 4, but the digital camera 1 and printer 4 can be connected by a USB cable 92 (generally, transmission cable) as in a printing system 103 shown in FIG. 22, so that the captured images and auto-print file may be exchanged by way of the USB cable 92. The USB cable 92 is connected to the USB interface 17 of the digital camera 1 and the USB interface 52 of the printer 4. In this case, in trial use, the digital camera 1 can record the captured image in the flash ROM 37, the internal memory, same as in the third preferred embodiment. The printer 4 acquires the captured image and auto-print file from the memory card 91 or the flash ROM 37 as a memory device associated with the digital camera 1.

As shown in FIG. 23, a function nearly same as in the printing system 101 in the first and second preferred embodiments can be realized by a printing system 104 composed of digital camera 1, computer 6 and printer 7. Herein, the digital camera 1 is same as the one used in the first or second preferred embodiment. The computer 6 may be a general computer comprising CPU, RAM, ROM, hard disk, and reading device of recording medium, and the printer 7 may be a general consumer printer.

In this printing system 104, the printer 7 is connected to the computer 6, and is designed to print according to the print instruction from the computer 6. The computer 6 has a memory card slot, and the captured images and auto-print file of the digital camera 1 is given to the computer 6 through a memory card 91. Of the processes shown in FIGS. 12 and 13, other processes than printing itself are executed in the computer 6, and the printing is performed by the printer 7. That is, the operation by the computer 6 includes the process of preparing captured images, the process of generating data for printing by adding the description information about the digital camera to the captured image, and others. Such functions of the computer 6 are realized by the computation process by the CPU according to the specified program. The program is read out from recording medium 93 such as CD-ROM storing the program, or downloaded from a specified server device through an electric communication line, and stored in the hard disk of the computer 6.

The description information about the digital camera such as an ad image and an ad moving image stored in the flash ROM 67 of the printer 4 in the first and second preferred embodiments may be properly updated by reading from the memory card 91 or downloading from a specified server device through an electric communication line.

In the third preferred embodiment, too, the commutation method of the digital camera 1 and printer 5 is not limited to the wired system, but may be realized by wireless system.

In the foregoing preferred embodiments, the print size or actual print size in the “trial use mode” is limited to the reference size of “L-size” only, but generally the size may be limited to the reference size or smaller. For example, if the reference size is the “L-size”, in the case of a print size smaller than the “L-size” (for example, name card size), it is not necessary to change it to the “L-size”.

In these preferred embodiments, the printing condition is specified by the number of prints and print size only, but may include other conditions, such as printing quality, printing color, or printing direction. Whatever condition may be included in the printing condition, the available printing condition in the “trial use mode” is preferred to be limited than the allowable condition in the “normal mode”.

In the preferred embodiments, by the computation process by the CPU according to the program, the processing functions about printing are realized, but all or part of such functions may be realized in an exclusive electric circuit. In particular, by building repetitive operation functions by a logic circuit, high speed operation is realized.

While the invention has been shown and described in detail, the foregoing description is in all aspects illustrative and not restrictive. It is therefore understood that numerous modifications and variations can be devised without departing from the scope of the invention.

1. A digital camera having a first mode for trial use and a second mode for non-trial use, comprising:
an image capturing part for capturing an image of a subject to acquire the captured image and recording the captured image in a memory device; and
a processing part for performing a printing related process regarding printing of said captured image, wherein
said processing part changes a content of said printing related process between said first mode and said second mode.

2. The digital camera according to claim 1, wherein
in said first mode, said processing part adds description information about said digital camera to said captured image to generate data for printing.

3. The digital camera according to claim 1, wherein
said printing related process includes a process of setting the number of prints of said captured image, and
in said first mode, said processing part sets said settable number of prints to a reference number or less, said reference number being smaller than a maximum permissive number permitted in said second mode.

4. The digital camera according to claim 1, wherein
said printing related process includes a process of setting a print size of said captured image, and
in said first mode, said processing part sets said settable print size to a reference size or smaller, said reference size being smaller than a maximum permissive size permitted in said second mode.

5. The digital camera according to claim 1, wherein
said memory device includes an internal memory of said digital camera, and a portable recording medium which can be inserted into said digital camera,
said image capturing part can record said captured image in both said internal memory and said portable recording medium, and
in said first mode, said image capturing part records said captured image in said internal memory.

6. The digital camera according to claim 1, further comprising:
a transmitter for transmitting said captured image to a printer connected to said digital camera in a communicatable manner.

7. The digital camera according to claim 1, wherein
in said first mode, when said transmitter transmits said captured image to the printer, said processing part deletes the captured image from said memory device.

8. A printer having a first mode for trial use and a second mode for non-trial use, comprising:
an acquisition part for acquiring an image captured by a digital camera and stored in a memory device;
a processing part for performing a printing related process regarding printing of said captured image; and
a printing part for printing said captured image, wherein
said processing part changes a content of said printing related process between said first mode and said second mode.

9. The printer according to claim 8, wherein
said captured image contains identification information indicative of the type of the digital camera used for image capturing,
in said first mode, said processing part acquires description information about the digital camera, by which the captured image is acquired, on the basis of said identification information contained in said captured image, and
said processing part adds said acquired description information to said captured image to generate data for printing.

10. The printer according to claim 8, further comprising:
a display part for displaying information, wherein
said captured image contains identification information indicative of the type of the digital camera used for image capturing,
in said first mode, said processing part acquires description information about the digital camera, by which the captured image is acquired, on the basis of said identification information contained in said captured image, and
said processing part allows said display part to display said acquired description information while said printing part prints said captured image.

11. The printer according to claim 8, wherein
said printing related process includes a process of setting the number of prints of said captured image, and
in said first mode, said processing part sets said settable number of prints to a reference number or less, said reference number being smaller than a maximum permissive number permitted in said second mode.

12. The printer according to claim 8, wherein
said printing related process includes a process of setting a print size of said captured image, and
in said first mode, said processing part sets said settable print size to a reference size or smaller, said reference size being smaller than a maximum permissive size permitted in said second mode.

13. The printer according to claim 8, wherein
in said first mode, after said printing part prints said captured image, said processing part deletes the captured image from said memory device.

14. The printer according to claim 8, wherein
said acquisition part acquires said captured image from a portable recording medium which can be inserted into said printer.

15. The printer according to claim 8, wherein
said acquisition part acquires said captured image from a memory device associated with the digital camera connected to said printer in a communicatable manner.

16. A printing system including a digital camera for capturing an image of a subject to acquire the captured image and a printer for printing said captured image, comprising:
a storage part for storing description information about said digital camera; and
a generator for adding said description information to said captured image to generate data for printing.

17. A program product having a program being executable by a computer provided in relation to a printing system including a digital camera for capturing an image of a subject to acquire the captured image and a printer for printing said captured image, wherein
said program allows said computer to execute the processes of:
preparing said captured image; and
adding description information about said digital camera to said captured image to generate data for printing.
